(19) United States
(12) Patent Application Publication
(10) Pub. No.: US 2012/0091839 A1
(43) Pub. Date: Apr. 19, 2012

(54) ELECTRIC MOTOR

(75) Inventors: Bernd Hein, Baiersbronn/Schoenmuenzach (DE); Jerome Thiery, Strasbourg (FR); Christoph Heier, Iffezheim (DE); Christoph Klappenbach, Ottersweier-Unzhurst (DE); Thomas Lojowski, Ottersweier (DE); Petra Maly, Rastatt (DE)

(73) Assignee: ROBERT BOSCH GMBH, Stuttgart (DE)

(21) Appl. No.: 13/260,381

(22) PCT Filed: Jan. 27, 2010
(86) PCT No.: PCT/EP2010/050900

§ 371 Date: Dec. 21, 2011

(30) Foreign Application Priority Data
Mar. 24, 2009 (DE) 10 2009 001 808.5

(51) Int. Cl. H02K 11/00

(52) U.S. Cl. 310/71

(57) ABSTRACT

The invention relates to an electric motor, in particular for a pump in a motor vehicle. The electric motor has a housing, a stator and an armature. The electric motor also has a control unit which is preferably formed on a printed circuit board, wherein the printed circuit board is connected to the housing and/or to the stator via electrical connecting lines which are in particular in the form of wires and are solid. According to the invention, in the electric motor, the connecting points which each connect one connecting line to the printed circuit board are arranged together on one printed circuit board surface of the printed circuit board, on a contact area which is smaller than the printed circuit board area, such that mechanical deformation effects to the printed circuit board caused by temperature fluctuations and/or vibration at the connecting points are reduced to a minimum, or at least in comparison to an arrangement which is distributed in particular uniformly over the printed circuit board surface.

### BACKGROUND OF THE INVENTION

The invention relates to an electric motor, in particular for a pump of a motor vehicle. The electric motor has a housing, a stator and an armature. The electric motor also has a control unit which is preferably formed on a printed circuit board, with the printed circuit board being connected to the housing and/or to the stator via, in particular, wire-like, preferably solid, electrical connecting lines.

DE 10 2007 031 2461 discloses an electronic control apparatus for a power steering system, with the power steering system being designed to produce an assistance force for a steering system of a vehicle by means of a rotation force of an electric motor. The controller has a housing which accommodates a printed circuit board and press-in pins, with the printed circuit board being connected to the press-in pins.

### SUMMARY OF THE INVENTION

According to the invention, the connecting points in the case of the electric motor of the type cited in the introductory part, said connecting points in each case connecting a connecting line to the printed circuit board, are arranged together on a printed circuit board surface of the printed circuit board, in a contact area which is smaller than the printed circuit board surface, in such a way that mechanical deformation effects, which are caused by fluctuations in temperature and/or vibrations, on the printed circuit board at the connecting points are reduced to a minimum or at least in comparison to an arrangement which is distributed, in particular uniformly, over the printed circuit board surface.

This arrangement of the electrical connecting lines has the advantageous effect that connecting points, which connect the printed circuit board to the electrical connecting lines, advantageously cannot be changed, destroyed or interrupted by, in particular, thermal expansions or mechanical vibrations which cause a relative movement between the printed circuit board and the housing and/or the stator. The connecting points preferably form a group in the contact area; the contact area is further preferably circular.

In a preferred embodiment of the electric motor, the contact area is less than half the size of the printed circuit board surface, further preferably a third of the size of the printed circuit board surface, particularly preferably a quarter or a fifth of the size of the printed circuit board surface. This has the advantageous result that, in comparison to a contact area which corresponds to the printed circuit board surface, relative movements, which are caused by thermal expansions of the printed circuit board and/or of the connecting lines, are reduced to a minimum or at least in comparison to an arrangement which is distributed, in particular uniformly, over the printed circuit board surface.

In an advantageous embodiment of the electric motor, at least some of the electrical connecting lines have at least one loop or at least one meander, said loop and meander in each case being designed to absorb a force which acts in the longitudinal direction of the connecting line, and preferably to at least partially store said force, in particular with a spring. As a result, thermal expansions of the printed circuit board can advantageously be at least reduced or not act on the electrical connecting point. The loop is preferably formed by a half-wave of a sinusoidal or square wave. In a preferred embodiment of the electric motor, the printed circuit board is mounted in a floating manner in such a way that the printed circuit board is supported at least predominantly or exclusively by the connecting lines. These embodiments have the advantageous effect that mechanical forces and/or forces which are caused by thermal expansion can be transmitted to the connecting points only at least partially or cannot be transmitted to the connecting points at all.

The contact area is preferably arranged in the center of the printed circuit board surface. The floating mounting arrangement can be formed, for example, by the printed circuit board being connected to a housing of the electric motor by means of at least one coupling element, with the coupling element preferably having a lower modulus of elasticity than the printed circuit board and/or the housing. The coupling elements can be formed, for example, by an elastomer, for example silicone rubber or polyurethane. The printed circuit board is then advantageously mounted in a floating manner in such a way that the printed circuit board is supported at least predominantly by the connecting lines.

In a preferred embodiment, the connection between the printed circuit board and the connecting line is pressed. The pressed connection has the advantageous effect that both a mechanical connection and an electrical connection are established by the pressed arrangement between the connecting line and the printed circuit board.

In an advantageous embodiment, the connection between the printed circuit board and the connecting line is soldered. The soldered connection advantageously establishes an electrical connection between the printed circuit board and the connecting line. In this embodiment of the soldered connection, a mechanical connection between the printed circuit board and the connecting line is formed at least by the soldered point. In the case of the soldered connection, the printed circuit board is preferably connected to the housing and/or to the stator of the electric motor in such a way that the printed circuit board is supported at least predominantly by the connection between the printed circuit board and the housing. As a result, a mechanical loading on the soldered point is advantageously low.

In a preferred embodiment of the electric motor, the printed circuit board is substantially or exactly circular and is arranged transverse to a motor shaft axis. The motor shaft axis preferably runs through the contact area, in particular a center of gravity of the contact area. The contact area is advantageously arranged in the center of the printed circuit board surface.

The arrangement of the contact area in such a way that the motor shaft axis runs through the contact area has the advantageous effect that oscillations of the housing of the electric motor, which are caused by rotation of the motor shaft, in particular with a motor armature, advantageously act only slightly on the connecting points or do not act on the connecting points.

In a preferred embodiment of the electric motor, the connecting points of connecting lines of a component are arranged on a radial, with the radial extending from a point of the contact area to an edge of the printed circuit board. The point of the contact area is preferably a center of gravity of the contact area, a center of gravity of the surface of the printed circuit board, a center point of the contact area or a point through which the motor shaft axis runs. The above-described arrangement has the advantageous effect that connecting lines, in particular connections of a component, which connect the component to the printed circuit board, are preferably slightly mechanically loaded or are not mechanically loaded in the event of thermal expansions and/or mechanical deformations of the printed circuit board.

### BRIEF DESCRIPTION OF THE DRAWINGS

The invention will now be described below with reference to figures and further exemplary embodiments.

FIG. 1 shows an exemplary embodiment of a pump for a motor vehicle having an electric motor. In the pump, a printed circuit board is connected to electrical contacts of the electric motor in such a way that mechanical deformation effects, which are caused by fluctuations in temperature, on the printed circuit board at the connecting points are reduced in comparison to a uniform distribution over the printed circuit board surface;

FIG. 2 shows an exemplary embodiment of connecting lines which has looped and meandering longitudinal sections;

FIG. 3 shows an exemplary embodiment of a Hall sensor which has connecting lines which are designed to electrically connect the Hall sensor and which have at least one loop in each longitudinal section;

FIG. 4 shows an exemplary embodiment of an electric motor, in which contacts of connecting lines are connected to a printed circuit board, with the printed circuit board being connected to a housing of the electric motor by means of a connecting web;

FIG. 5 shows a plan view of an exemplary embodiment of the electric motor shown in FIG. 4 without the printed circuit board;

FIG. 6 shows an electric motor, in which the printed circuit board is supported in a floating manner by connecting lines which are in each case connected to a housing and/or stator of the electric motor and are in each case in the form of press-in pins.

### DETAILED DESCRIPTION

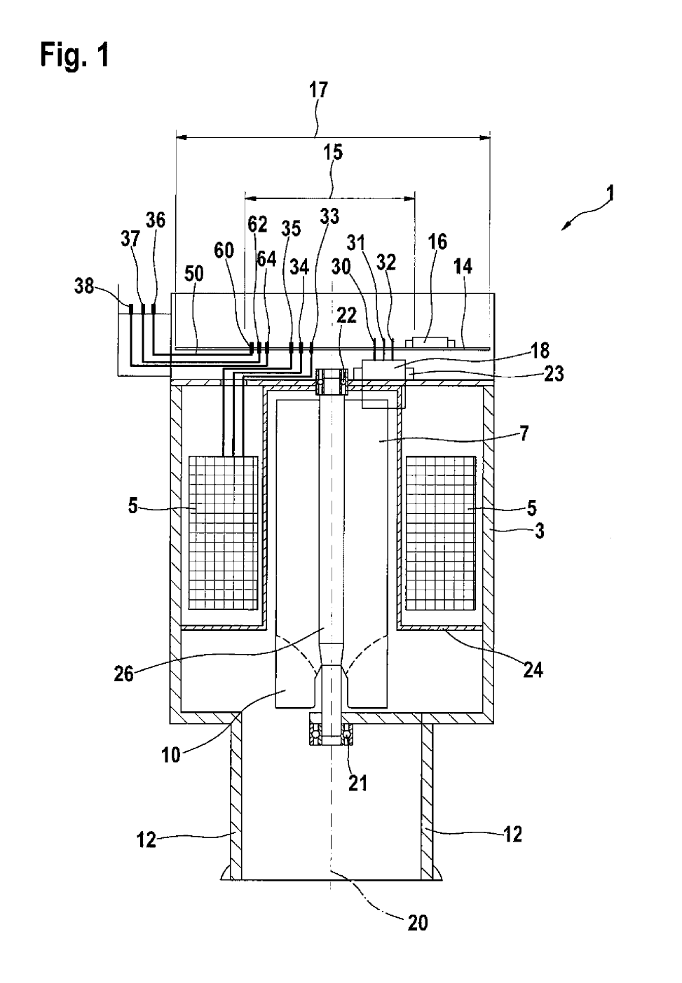

FIG. 1 shows an exemplary embodiment of a pump 1. The pump 1 has a housing 3, with the housing 3 surrounding an electric motor. The electric motor has a stator comprising at least one stator coil 5. The electric motor also has an armature 7 which is permanently magnetic in this exemplary embodiment. The armature 7 is connected to an impeller 10 which is integrally formed on the armature 7 in this exemplary embodiment. The armature 7, which forms a rotor of the electric motor in this exemplary embodiment, is mounted so as to rotate about a motor shaft axis 20 by means of a bearing 21 and a bearing 22.

The pump 1 also has a pump housing 24 which is accommodated by the housing 3. The pump 1, in particular the electric motor of the pump 1, also has a printed circuit board 14. The printed circuit board 14 is accommodated and arranged by the housing 3 in such a way that a printed circuit board plane of the printed circuit board 14 runs transverse to the motor shaft axis 20.

The printed circuit board 14 has a plurality of conductor tracks—not illustrated in this figure—which connect contacts of components, in particular electronic components, to one another, with the components being arranged on the printed circuit board 14. A module 16 which is connected to the printed circuit board 14 is illustrated. The module 16 is, for example, a SMD module (SMD=Surface−Mounted Device).

The electric motor also has a Hall sensor 18. The Hall sensor 18 is arranged in such a way that a rotational frequency of the armature 7 can be detected by the Hall sensor 18. The Hall sensor 18 is designed to generate an output signal as a function of the rotation of the armature 7, said output signal representing the rotational frequency. The Hall sensor 18 has three connecting lines for making electrical contact with the Hall sensor 18, specifically a connecting line 30, a connecting line 31 and a connecting line 32. The connecting lines 30, 31 and 32 are in each case arranged in a region 15 with the printed circuit board 14. The region 15 forms a contact area which is smaller than a printed circuit board surface of the printed circuit board 14. A diameter 17 of the printed circuit board 14 is also illustrated.

The at least one stator coil 5 is connected to the printed circuit board 14 in the region 15 by means of connecting lines 33, 34 and 35.

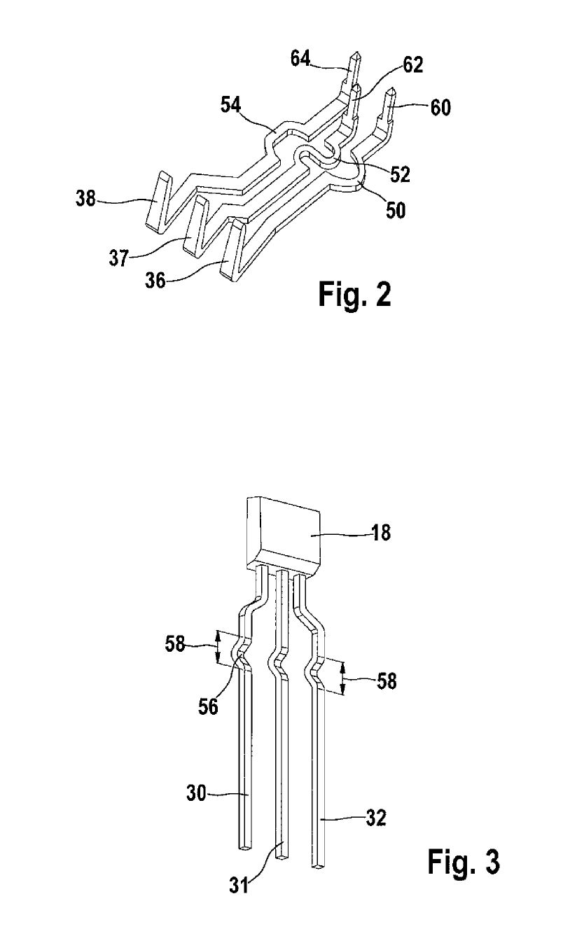

The pump 1 also has an electrical connection, with the electrical connection comprising three connecting lines, specifically a connecting line 36, a connecting line 37 and a connecting line 38. The connecting lines 36, 37 and 38 are in each case in the form of contact pins in the electrical connection, and therefore a plug can make contact with the connecting lines 36, 37 and 38 at least in sections in the region of one end. The connecting line 36 is connected to the printed circuit board 14 in the region 15 in the region of another end 60. A looped region 50, which is described in greater detail in FIG. 2, is also identified. The connecting line 37 is connected to the printed circuit board 14 by means of another end 62 in the region 15. The connecting line 38 is connected to the printed circuit board 14 in the region of another end 64 in the region 15. The connecting lines 30, 31, 32, 33, 34, 35, 36, 37 and 38 can in each case be connected to the printed circuit board 14 both by means of a pressed connection and a soldered connection.

The housing 3 of the pump 1 also has a connection flange 12 which is designed to connect the pump 1—for example to a cooling system of an internal combustion engine—such that it carries fluid. The housing 3 also has a holding apparatus 23 which is integrally formed on said housing and is designed to accommodate and firmly hold the Hall sensor 18.

The connecting line 36 has, in one section, a loop—illustrated in greater detail in FIG. 2—which is designed to absorb forces which act in the longitudinal direction of the connecting line 36.

FIG. 2—schematically—shows an exemplary embodiment of the connecting lines 36, 37 and 38 which have already been illustrated in FIG. 1. The connecting line 36 has a loop 50 in the region of a longitudinal section, said loop being semicircular in this exemplary embodiment. The loop 50 merges with a further section of the connecting line 36, with the connecting line 36 being designed for mechanical and/or electrical connection to the printed circuit board 14, which has already been illustrated in FIG. 1, in the region of one end 60. The connecting line 36 has a start section and an end section, said sections in each case being angled—so as to point in the same direction.

The connecting line 37 has a meandering section 52. The meandering section 52 resembles a sinusoidal wave in this exemplary embodiment. The meandering section 52 of the connecting line 37 is designed to store forces—which are caused, for example, by thermal expansion—which act in the longitudinal direction of the connecting line 37, and thus to relieve the mechanical load on the connecting points of the connecting line 37. The connecting line 37 has two ends which are in each case angled so as to point in the same direction. The meandering section 52 turns into an end section 62 of the connecting line 37 which is designed for connection to a printed circuit board, for example the printed circuit board 14 which is illustrated in FIG. 1. The connecting line 38 has two ends, with one end 64 being designed for connection to a printed circuit board, and with the ends in each case being angled so as to point in the same direction. A longitudinal section which forms a loop 54 extends between the ends of the connecting line 38. The loop 54 is designed to absorb forces which act in the longitudinal direction of the connecting line 38, and thus to relieve the mechanical load at least on the end 64 which is designed for connection to a printed circuit board.

FIG. 3 schematically shows an exemplary embodiment of a Hall sensor 18. The Hall sensor 18 has three electrical connections, specifically an electrical connection 30, an electrical connection 31 and an electrical connection 32. The electrical connections 30, 31 and 32 are in each case in the form of connection legs. The connections 30, 31 and 32 in each case have a longitudinal section 58 which is in each case formed by a loop 56. The loop 56 is identified, by way of example, on the connection 30. The loop 56 has a half-wave shape in this exemplary embodiment. The loop 56 is designed to store a deformation which acts in the longitudinal direction of the connection 30, and thus to relieve the mechanical load on a connecting point, for example a soldered point, which connects the connection 30 to a printed circuit board.

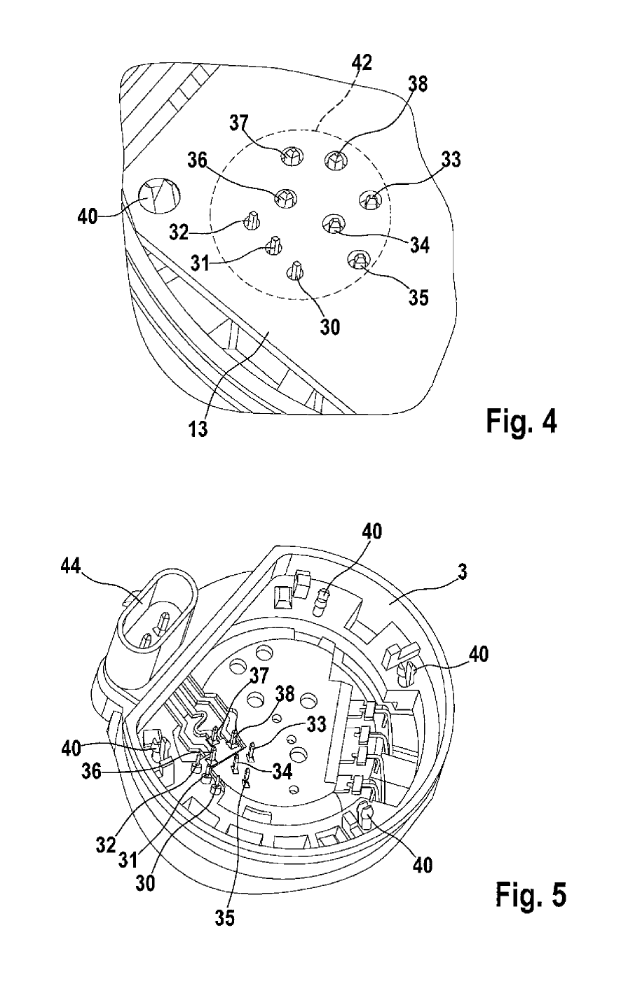

FIG. 4 shows an exemplary embodiment of an electric motor in which connections of electrical connecting lines, which are, in particular mechanically, connected to a housing of the electric motor, are connected to a printed circuit board 13 by means of a soldered connection on a contact area 42 and combined to form a group in such a way that mechanical forces, which are caused by fluctuations in temperature in particular, on the connections are minimal. The plan view illustrated in FIG. 4 shows the connections of the connecting lines 30, 31 and 32 of the Hall sensor 18 which is illustrated in FIG. 1, said connections in each case projecting out of the printed circuit board 13 and being routed through said printed circuit board.

Connections of the connecting lines 33, 34, 35, 36, 37 and 38 which have already been illustrated in FIG. 1, are in each case routed through the printed circuit board 13 and project out of the printed circuit board 13 are also illustrated. The contact area 42 is, for example, circular.

The printed circuit board 13 is mechanically connected to the housing of the electric motor by means of a bayonet pin 40.

FIG. 5 shows a plan view of the electric motor, of which a section has already been illustrated in FIG. 4. The electric motor has a housing 3, with a connection 44 for electrical connection of the electric motor—for example to a control unit or to a supply voltage source—being integrally formed on the housing 3. The plan view which is illustrated in FIG. 5 shows the electric motor without the printed circuit board 13 which is illustrated in FIG. 4. The bayonet pin 40, the connecting lines 30, 31, 32, 33, 34, 35, 36, 37 and 38, which are in each case mechanically connected to the housing 3 of the electric motor, can be seen.

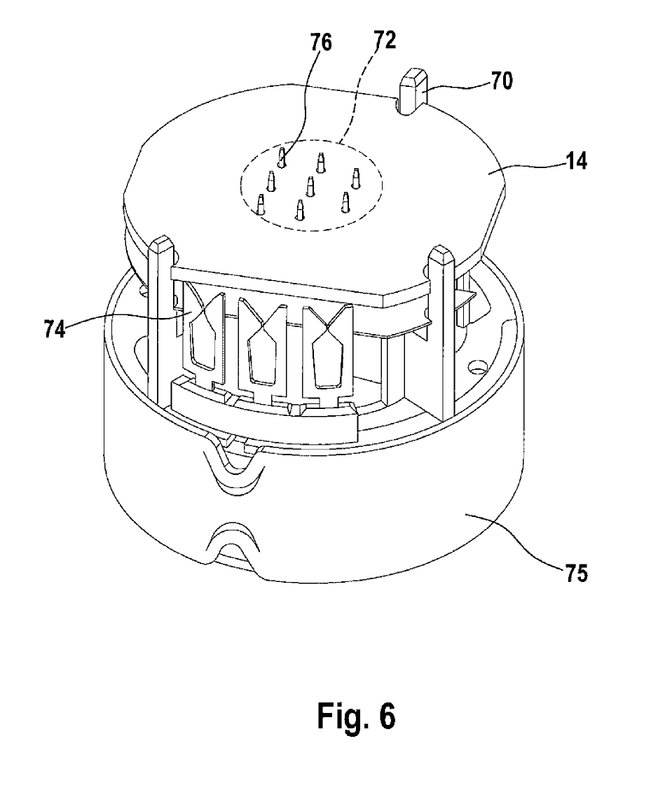

FIG. 6 shows an exemplary embodiment of an electric motor in which—as in FIG. 1—a printed circuit board 14 is supported by electrical connecting lines, with the electrical connecting lines being connected to a housing of the electric motor, in this exemplary embodiment to a stator 75. In this exemplary embodiment, the printed circuit board surface of the printed circuit board 14 has, at least in sections or predominantly, a circular circumference. The printed circuit board 14 has a contact area 72 which is arranged in the center of the printed circuit board 14, with the printed circuit board 14 being supported in the region of the contact area 72 by means of the electrical connecting lines 76.

The electric motor also has guide webs which are in each case mechanically connected to the stator 75 and which engage in corresponding cutouts in the printed circuit board 14. The printed circuit board 14 is held by the connections 76 in such a way that the printed circuit board 14 is mounted in a floating manner and does not touch the guide webs. A guide web 70 is identified by way of example.

The electric motor also has electrical connections for electrically connecting the electric motor to a supply voltage source or a control unit. In this exemplary embodiment, the electric motor has three electrical connections, of which the connection 74 is identified by way of example. In this exemplary embodiment, the electrical connections are in each case in the form of split contacts, it being possible for provision to be made for connecting lines for connecting the electric motor—for example the connecting lines 36, 37 and 38 in FIG. 1—to be connected to the split contacts. To this end, the connecting lines 36, 37 and 38 can in each case be connected to a housing cover, it being possible for one end of the connecting lines 36, 37 and 38 to engage in a tongs-like connection 74. A further section of the connecting lines, which are in each case routed through the printed circuit board 14 by way of an end section and—like the connecting line 46—project out of the printed circuit board 14 and make both mechanical and electrical contact with said printed circuit board, runs between the tongs-like connection 74 and the printed circuit board 14. The connecting lines 36, 37 and 38 can in each case be in the form of press-in pins.

1. An electric motor (3, 5, 7) having a housing (3), a stator (5) and an armature (7), with the electric motor having a control unit (16, 23) which is formed on a printed circuit board (14), with the printed circuit board being connected to one of the housing (3) and the stator (5) via wire-like, solid electrical connecting lines (30, 31, 32, 33, 34, 35, 60, 62, 64), characterized in that connecting points, which in each case connect a connecting line (30, 31, 32, 33, 34, 35, 60, 62, 64) to the printed circuit board (14), are arranged together on a printed circuit board surface (17) of the printed circuit board (14), in a contact area (15) which is smaller than the printed circuit board surface (17), in such a way that mechanical deformation effects, which are caused by one of fluctuations in temperature and vibrations, on the printed circuit board (14) at the connecting points (30, 31, 32, 33, 34, 35, 60, 62, 64) are reduced to a minimum or at least in comparison to an arrangement which is distributed over the printed circuit board surface (17).

2. The electric motor (3, 5, 7) as claimed in claim 1, characterized in that the contact area (15) is less than half the size of the printed circuit board surface (17)

3. The electric motor (3, 5, 7) as claimed in claim 1, characterized in that at least some of the electrical connecting lines (30, 31, 32, 33, 34, 35, 60, 62, 64) have at least one loop or at least one meander, said loop and meander in each case being designed to absorb a force which acts in the longitudinal direction of the connecting line.

4. The electric motor (3, 5, 7) as claimed in claim 1, characterized in that the printed circuit board (14) is mounted in a floating manner in such a way that the printed circuit board (14) is supported at least predominantly or exclusively by the connecting lines (30, 31, 32, 33, 34, 35, 60, 62, 64).

5. The electric motor (3, 5, 7) as claimed in claim 4, characterized in that the connection between the printed circuit board (14) and the connecting line (76) is pressed.

6. The electric motor (3, 5, 7) as claimed in claim 1, characterized in that the connection between the printed circuit board (14) and the connecting line is soldered.

7. The electric motor (3, 5, 7) as claimed in claim 1, characterized in that the printed circuit board (14) is substantially or exactly circular and is arranged transverse to a motor shaft axis (20), with the motor shaft axis (20) running through the contact area (15).

8. The electric motor (3, 5, 7) as claimed in claim 1, characterized in that the connecting points of connecting lines of a component (5, 18) are arranged on a radial, with the radial from a point of the contact area extending to an edge of the printed circuit board (13, 14).

9. The electric motor as claimed in claim 1 wherein the motor is for a pump of a motor vehicle.

10. The electric motor (3, 5, 7) as claimed in claim 1, characterized in that the printed circuit board (14) is substantially or exactly circular and is arranged transverse to a motor shaft axis (20), with the motor shaft axis (20) running through a center of gravity of the contact area (15).

11. The electric motor (3, 5, 7) as claimed in claim 2, characterized in that at least some of the electrical connecting lines (30, 31, 32, 33, 34, 35, 60, 62, 64) have at least one loop or at least one meander, said loop and meander in each case being designed to absorb a force which acts in the longitudinal direction of the connecting line.

12. The electric motor (3, 5, 7) as claimed in claim 11, characterized in that the printed circuit board (14) is mounted in a floating manner in such a way that the printed circuit board (14) is supported at least predominantly or exclusively by the connecting lines (30, 31, 32, 33, 34, 35, 60, 62, 64).

13. The electric motor (3, 5, 7) as claimed in claim 12, characterized in that the connection between the printed circuit board (14) and the connecting line (76) is pressed.

14. The electric motor (3, 5, 7) as claimed in claim 13, characterized in that the connection between the printed circuit board (14) and the connecting line is soldered.

15. The electric motor (3, 5, 7) as claimed in claim 14, characterized in that the printed circuit board (14) is substantially or exactly circular and is arranged transverse to a motor shaft axis (20), with the motor shaft axis (20) running through the contact area (15).

16. The electric motor (3, 5, 7) as claimed in claim 15, characterized in that the connecting points of connecting lines of a component (5, 18) are arranged on a radial, with the radial from a point of the contact area extending to an edge of the printed circuit board (13, 14).
